(19) United States
(12) Patent Application Publication
(10) Pub. No.: US 2008/0262689 A1
(43) Pub. Date: Oct. 23, 2008

(54) Method of Operating A Vehicle

(75) Inventors: Ian John Sayers, Asbourne (GB); Charles David Nicklin, Sandbach (GB)

Correspondence Address: MARSHALL, GERSTEIN & BORUN LLP, 233 S. WACKER DRIVE, SUITE 6300, SEARS TOWER, CHICAGO, IL, 60606, US

(73) Assignee: JCB Landpower Limited, Uttoxeter (GB)

(21) Appl. No.: 12/103,489

(22) Filed: Apr. 15, 2008

(30) Foreign Application Priority Data
Apr. 17, 2007 (GB) GB 0707344.8

(51) Int. Cl. G06F 19/00

(52) U.S. Cl. 701/70

(57) ABSTRACT

A method of operating a vehicle is described, in which the vehicle includes a frame structure carrying a ground engaging structure whereby the vehicle may travel over the ground, the ground engaging structure including a pair of steerable wheels which with the vehicle travelling in a travelling direction, are front wheels, and a pair of rear wheels which may each independently be braked by the operation of respective brake devices, the vehicle further including a controller which is capable of providing signals independently to the brake devices of the rear wheels to effect application and release of a selected brake, and the method including sensing the vehicle travelling speed and providing a first input to the controller, sensing steering of the vehicle by the operator and providing a second input to the controller, and where the travelling speed is below a threshold speed, and depending on the direction of steering of the vehicle, the controller applying one of the brakes.

### BACKGROUND OF THE INVENTION

This invention relates to a method of operating a vehicle and more particularly but not exclusively to a method of operating a vehicle which in addition to being designed to be driven on a road, is designed to perform off-road working operations. Thus the vehicle may be a tractor, and/or a working machine of the kind including one or more working arms which are manipulatable by powered e.g. hydraulic, actuators, for performing excavating and/or loading operations.

Tractors, particularly but not exclusively those which have relatively large rear wheels compared to relatively smaller front wheels, can be difficult to steer particularly in off-road conditions, mainly due to the rear biased weight distribution, and rear mounted work implements.

Conventional tractors i.e. tractors which are only capable of relatively low road speeds, e.g. below 50 kph, may be provided with a pair of brake pedals each of which is effective when operated to apply a brake to a single rear wheel. The brake pedals are coupleable by means of a coupling, so that when the tractor is driven on a road, an operator can only apply the brakes to the two rear wheels simultaneously and together, but for off-road conditions, with the coupling removed or otherwise inoperative, the rear wheels can individually be braked whilst steering is effected, so that a kind of skid-steer is performed, thereby enhancing the steering of the tractor.

However, known couplings for coupling the pair of brake pedals, which need manually to be applied, sometimes are not applied by operators when these are required, leading to the tractor being road driven with a pair of brake pedals needing to be operated to achieve safe braking.

For higher speed tractors which are able to travel on-road at higher speeds, for example only, up to 80 kph, it is a legal requirement in at least some countries for there to be a dual circuit braking system operated by a single brake pedal only. Accordingly hithertofore tractors capable of higher speeds on-road, have not been provided with any skid-steer ability for enhanced steering.

### SUMMARY OF THE INVENTION

According to a first aspect of the invention we provide a method of operating a vehicle which includes a frame structure carrying a ground engaging structure whereby the vehicle may travel over the ground. The ground engaging structure includes a pair of steerable wheels which with the vehicle travelling in a travelling direction, are front wheels, and a pair of rear wheels which may each independently be braked by the operation of respective brake devices. The vehicle further includes a controller which is capable of providing signals independently to the brake devices of the rear wheels to effect application and release of a selected brake. The method includes sensing the vehicle travelling speed and providing a first input of the controller, sensing steering of the vehicle by the operator and providing a second input to the controller, and where the travelling speed is below a threshold speed and depending on the direction of steering of the vehicle, the controller applying one of the brakes. The method includes applying the brake device of the wheel on the side of the vehicle to which the vehicle is being steered, to a degree depending upon the magnitude of the angle through which the vehicle is being steered and/or the vehicle speed.

Thus the invention enables steering to be enhanced automatically upon steering being sensed, but only provided that the vehicle is travelling at below a threshold speed, e.g. in off-road conditions, by the controller applying the brake device to the wheel on the side of the vehicle to which the vehicle is being steered. Thus the vehicle may travel rapidly conventionally on-road, but with steering assist being applied at slower speeds, e.g. off-road.

The invention is particularly but not exclusively applicable where the vehicle includes a single operator brake pedal which when operated applies the brakes on both rear wheels of the vehicle via separate brake circuits. Thus the invention may be applied to a tractor or other vehicle which is capable of higher speed travel on the road, as only a single brake pedal is required for the operator to achieve braking on both rear wheels simultaneously, but in off-road conditions, the advantages of a conventional tractor which is able to have its steering enhanced by the provision of independently operable brake pedals, can be realised.

Where the ground engaging structure of the vehicle has front wheels and rear wheels, with a brake device for each of its wheels, the controller preferably applies a rear wheel braking only to enhance steering when the vehicle speed is below the threshold, but the brake pedal may operate the brake devices of all of the wheels when activated by the operator, to apply all the brakes.

Desirably the method includes sensing the steering angle and only applying the one of the brakes upon the steering angle being sensed being greater than a minimum steering angle.

According to a second aspect of the invention we provide a vehicle with a frame structure carrying a ground engaging structure whereby the vehicle may travel over the ground. The ground engaging structure includes a pair of steerable wheels which with the vehicle travelling in a travelling direction, are front wheels, and a pair of rear wheels which each are independently brakable by the application of respective brake devices. The vehicle further includes a controller which is capable of providing signals independently to the brake devices of the rear wheels to effect application and release of a selected brake, a first sensor device for sensing the vehicle travelling speed and providing a first input to the controller, a second sensor device for sensing steering of the vehicle by the operator and providing a second input to the controller. The controller is programmed to respond to the first and second inputs to apply one of the brake devices depending upon whether the travelling speed is below a threshold speed and depending on the direction of steering of the vehicle. The degree to which the brake device is applied depends upon the magnitude of the angle through which the vehicle is being steered and/or the vehicle speed.

### BRIEF DESCRIPTION OF THE DRAWINGS

Embodiments of the invention will now be described with reference to the accompanying drawings in which:

FIG. 1 is a side view of a vehicle for which the method of the present invention may be performed;

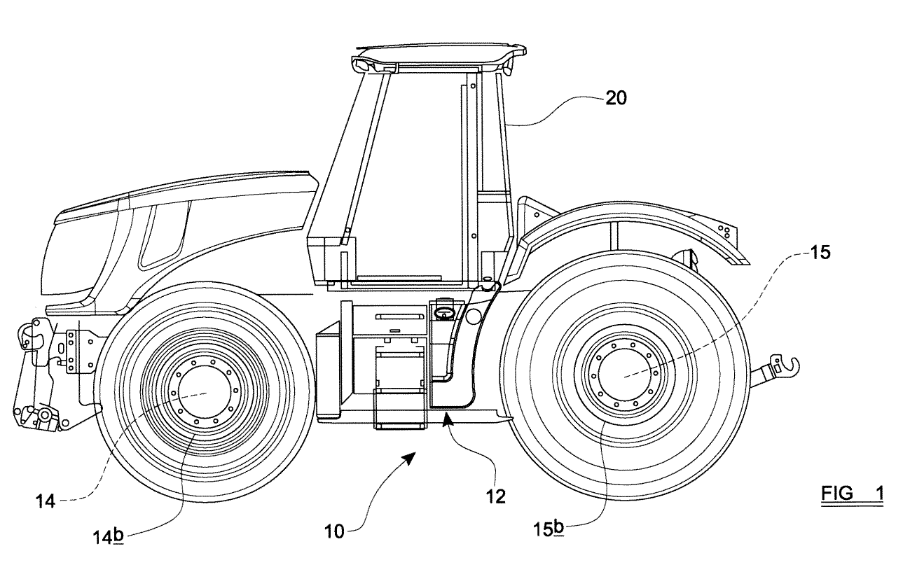

FIG. 2 is an illustrative diagram of part of the vehicle of FIG. 1.

### DESCRIPTION OF THE PREFERRED EMBODIMENT

Referring to the drawings there is shown a vehicle 10 which includes a frame structure 12 which in this example includes a chassis and body. The frame structure 12 carries a ground engaging structure which in this example includes a front axle 14 carrying a pair of steerable front wheels 14a, 14b and in this example a rear axle 15 carrying a pair of non-steerable rear wheels 15a, 15b.

In the example, the rear wheels 15a, 15b only are driveable via a mechanical transmission 17 by an engine 18, which in the present example is an internal combustion engine although in another example all four wheels 14a, 14b, 15a, 15b or indeed only the front wheels 14a, 14b may be drivable, depending on the kind of vehicle to which the invention is applied. The wheels 15a, 15b are drivable via a differential 16.

The vehicle 10 further includes an operator's cab 20 from where the vehicle 10 may be driven, there being within the cab 20 a steering control i.e. steering wheel 22 in this example, an accelerator or throttle pedal 23 and a brake pedal 24.

The speed of the vehicle 10 may be changed by the operator pressing the accelerator pedal 23 and/or by changing the transmission ratio between the engine 18 and the driven wheels 15a, 15b, there being a first sensor 25 either on the transmission 17 as indicated, or on the engine 18, axle 14, 15 or a wheel 14a, 14b, 15a, 15b or elsewhere as desired, to provide a first input 26 to a vehicle controller 30, indicative of the vehicle 10 travelling speed over the ground.

Steering of the front wheels 14a, 14b of the vehicle 10 may be effected by the operator actuating the steering wheel 22, which in the present example, imparts a steering movement to a an e.g. hydraulic, or other servo assisted mechanical or other steering transmission which in the present example includes a steering box 32 and rack and pinion steering mechanism. In this example the front wheels 14a, 14b are coupled by a steering rod 35 which is pivotally connected at each end to a swivel connection 36a, 36b of a front wheels 14a, 14b to be steered, the wheels 14a, 14b each being mounted on a respective swivel 38a, 38b for swivelling movement about respective generally upright axes 40a, 40b relative to the front axle 14.

Either provided on the steering rod 35 or anywhere else on the steering transmission or even on the steering wheel 22 or elsewhere, there is provided a second sensor 42 which senses that the vehicle 10 is being steered, and provides a second input 43 to the controller 30, which in this example, is indicative of the degree of steering of the wheels 14a, 14b, i.e. the steering angle.

Upon an operator actuating the brake pedal 24, braking of all of the wheels 14a, 14b, 15a, 15b is achieved. Each wheel 14a, 14b, 15a, 15b has an associated brake device 45a, 45b, 45c, 45d which in this example is hydraulically activated to apply a braking force to brake the associated wheel. In the example, the brake devices 45a, 45b, 45c, 45d are all hydraulically operated by pressurised hydraulic fluid from a common master cylinder 48 but the invention may be applied to vehicles having alternative braking systems as required, for example hydro-pneumatic braking systems. Preferably though, and not as shown in the drawings, dual brake circuits are provided so that on normal braking, one opposite pair of front and rear brake devices 45a and 45c are operated via one brake circuit, and the other opposite front and rear pair 45b, 45d of brake devices are operated via a second brake circuit.

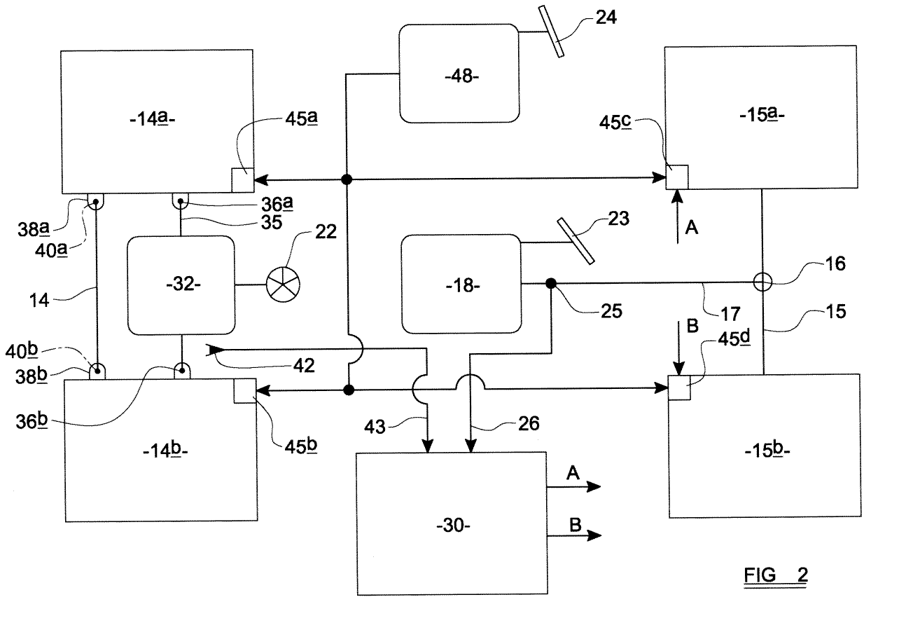

As well as being operated upon by an operator applying the brakes by depressing the foot pedal 24, each of the brake devices 45c, 45d of the rear wheels 15a, 15b is capable of operation independently in response to a respective signal A, B from the controller 30. This may be achieved in many different ways and FIG. 2 merely illustrates diagrammatically that this is possible. For example where the brake devices 45c, 45d are hydro-pneumatic, the signals A, B from the controller 30 may open a respective hydraulic valve to cause a respective brake device 45c, 45d to be applied independently of any pneumatic braking pressure. The controller 30 could alternatively cause operation of a braking system which is independent of the braking system by which the vehicle 10 is conventionally braked in another example,

The controller 30 is programmed e.g. with a suitable algorithm to respond to the inputs 26, 43 from the travel speed first sensor 25 and the steering angle second sensor 42 to apply one of the brake devices 45c, 45d to brake one of the rear wheels 15a, 15b to enhance steering of the vehicle 10 at slow travelling speeds.

For example, if the vehicle 10 is steered to swivel the front wheels 14a, 14b clockwise about their respective swivel axes 40a, 40b such that the vehicle 10 would if moving forwards, move to the right, the rear right hand side rear wheel 15a on the same side of the vehicle 10 as the direction in which the vehicle 10 is being steered, would be braked, to enhance steering, the vehicle 10 thus performing a kind of skid-steering action. Thus the turning circle achievable compared with just swivelling the front wheels 14a, 14b will be reduced.

It will be appreciated that the magnitude of the torque provided by the engine 18 via the transmission 17 remains the same as the driven wheel 15a is braked, the differential between the driven wheels 15a, 15b transfers torque to wheel 15b.

Desirably the input from the first sensor 25 is indicative of the actual travelling speed and the controller 30 determines whether the vehicle speed is above or below a threshold speed, and only in the event that the vehicle 10 travelling speed is below the threshold speed will the controller 30 act automatically to operate the respective brake device 45c, 45d. Moreover the controller 30 uses the input 26 from the travelling speed first sensor 25 and/or the steering angle second sensor 42 to control the amount of application of the brake e.g. so that at very slow vehicle speeds, the respective wheel 15a, 15b may be locked or virtually so, whereas as greater speeds, but still below the threshold speed, only partial braking may be applied, and so that the braking effect may be increased for greater steering angles.

The input 43 from the second, steering sensor 42 may indicate not only whether the vehicle 10 is being steered, but may include third input information relating to the degree of such steering in that direction. The controller 30 may respond by operating the respective brake device 45c, 45d to apply more braking force to a relevant wheel 15a, 15b as the steering angle increases. Desirably, the controller 30 only operates the respective brake device 45c, 45d when the steering angle is greater than a minimum steering angle, so that braking is not effected where an operator is e.g. making small adjustments, e.g. to keep the vehicle in a straight ahead travelling direction.

The algorithm with which the controller 30 is programmed may include other logic and require other inputs. For example, the controller 30 may include an input (not shown) from the brake pedal 24 or otherwise from the braking system, to indicate when the brake devices (45a, 45b, 45c, 45d) are being applied by the operator, in which case the controller 30 may cease to operate one only of the rear brake devices 45c, 45d, such that each of the brake devices 45a, 45b, 45c, 45d is operable in response to the input from the brake pedal 24 or otherwise.

Desirably the controller 30 includes a switch by means of which the responsiveness to the inputs 26, 43 may be disabled, for example when the vehicle 10 is being driven on-road even at low speeds below the threshold speed, which switch may be operator controlled, or automatically actuated. The actions of the controller 30 to apply the one brake device 45c, 45d may be disabled by an input from a sensor sensing a front or rear towing linkage position, or that a differential lock has been engaged.

Various modifications may be made without departing from the scope of the present invention.

The vehicle 10 may be of the kind in which all four wheels 14a, 14b, 15a, 15b are steerable, so that that the vehicle 10 may be operated in two wheel steering mode substantially as described above in relation to the illustrated embodiments, or four wheel steering mode. Such vehicles typically have two alternative four wheel steering modes namely “cramp” mode in which the front wheels 14a, 14b are swivelled in the opposite directions to the directions in which the rear wheels 15a, 15b are swivelled, and “crab” mode in which all four wheels 14a, 14b, 15a, 15b are swivelled in the same direction.

The present invention in which braking of a rear wheel 15a, 15b in the direction of travel is effected in response to travelling speed and input 26 from the steering sensor 25 is preferably only utilised with such a vehicle operating in two wheel steering mode as outlined above.

Although it is preferred that the amount of braking of the one brake device 45c, 45d depends upon the steering angle sensed by the second sensor 42, in another example, the amount of braking may be dependent only on the speed of the vehicle 10.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A method of operating a vehicle which includes a frame structure carrying a ground engaging structure whereby the vehicle may travel over the ground, the ground engaging structure including a pair of steerable wheels which with the vehicle travelling in a travelling direction, are front wheels, a pair of rear wheels which may each independently be braked by the operation of respective brake devices, the vehicle further including a controller which is capable of providing signals independently to the brake devices of the rear wheels to effect application and release of a selected brake, and the method including sensing the vehicle travelling speed and providing a first input of the controller, sensing steering of the vehicle by the operator and providing a second input to the controller, and where the travelling speed is below a threshold speed and depending on the direction of steering of the vehicle, the controller applying one of the brakes, wherein the method includes applying the brake device of the wheel on the side of the vehicle to which the vehicle is being steered, to a degree depending upon the magnitude of the angle through which the vehicle is being steered and/or the vehicle speed.

2. A method according to claim 1 wherein upon steering being sensed, provided that the vehicle is travelling at below a threshold speed, the controller applies the brake device to the wheel on the side of the vehicle to which the vehicle is being steered.

3. A method according to claim 1 wherein the vehicle includes a single operator brake pedal which when operated applies the brakes on both rear wheels of the vehicle via separate brake circuits.

4. A method according to claim 1 wherein the ground engaging structure of the vehicle has front wheels and rear wheels, with a brake device for each of its wheels, the method including applying a rear wheel brake only to enhance steering when the vehicle speed is below the threshold, or operating the brake pedal to operate the brake devices of all of the wheels when activated by the operator, to apply the brakes.

5. A method according to claim 1 wherein the method includes sensing the steering angle and only apply the one of the brakes when the steering angle sensed is greater than a minimum steering angle.

6. A vehicle with a frame structure carrying a ground engaging structure whereby the vehicle may travel over the ground, the ground engaging structure including a pair of steerable wheels which with the vehicle travelling in a travelling direction, are front wheels, a pair of rear wheels which each are independently brakable by the operation of respective brake devices, the vehicle further including a controller which is capable of providing signals independently to the brake devices of the rear wheels to effect application and release of a selected brake, a first sensor device for sensing the vehicle travelling speed and providing a first input to the controller, a second sensor device for sensing steering of the vehicle by the operator and providing a second input to the controller, the controller being programmed to respond to the first and second inputs to apply one of the brake devices depending upon whether the travelling speed is below a threshold speed and depending on the direction of steering of the vehicle, the degree to which the brake device is applied depending upon the magnitude of the angle through which the vehicle is being steered and/or the vehicle speed.
